(19) United States
(12) Patent Application Publication
(10) Pub. No.: US 2010/0037912 A1
(43) Pub. Date: Feb. 18, 2010

(54) DENTAL FLOSS APPARATUS

(76) Inventor: Gilbert Baughman, Findlay, OH (US)

Correspondence Address: JAY M. SCHLOFF, 6960 Orchard Lake Road, Suite 315, West Bloomfield, MI, 48322, US

(21) Appl. No.: 12/484,398

(22) Filed: Jun. 15, 2009

Related U.S. Application Data
(60) Provisional application No. 61/089,219, filed on Aug. 15, 2008.

(51) Int. Cl. A61C 15/04

(52) U.S. Cl. 132/323

(57) ABSTRACT

A dental floss apparatus comprises a body member and a shaft member. The body member comprises a broad proximal end portion and a narrow distal end portion. The broad proximal end portion comprises an attachment mechanism for attaching to an elongated handle member. The narrow distal end portion terminates in a protruding member. The shaft member comprises a first end portion and a second end portion. The first end portion comprises a hollow portion for being removably received over the protruding member. The second end portion comprises a forked tip portion disposed at a pre-determined angle to an axial line connecting the first end portion and the second end portion. The forked tip portion comprises a flossing member disposed therebetween. The flossing member is capable of being energized by a power source and is further capable of motion in at least one direction on being energized by the power source.

### CROSS REFERENCE TO RELATED APPLICATIONS

The present disclosure claims priority under 35 United States Code, Section 119 on the U.S. Provisional Patent Application No. 61/089,219 filed on Aug. 15, 2008, the disclosure of which is incorporated by reference.

### FIELD OF THE DISCLOSURE

The present disclosure generally relates to dental hygiene apparatuses, and, more particularly a dental floss apparatus for removal of dental plaque.

### BACKGROUND OF THE DISCLOSURE

Dental plaque is a soft, sticky bacterial coating that forms on teeth portions from mucus and bacteria present in human mouth. When the dental plaque comes in contact with sugars and starches present in food consumed by an individual, various acids are released which may lead to formation of dental cavities. Further, the acids may also cause irritation of gums around the teeth portions which may lead to gingivitis, a disease characterized by an inflammation of the gums. Furthermore, the dental plaque if not removed regularly, may build up on the teeth portions and become mineralized to form a tartar. The tartar formation on the teeth portions may only be removed by a dentist or a dental hygienist.

Various dental hygiene methods have been recommended for cleaning of the teeth portions and removal of the dental plaque. Typically, a toothbrush is used for cleaning of the teeth portions. However, cleaning of the teeth portions by the toothbrush may not adequately remove the dental plaque as the toothbrush may be incapable of accessing areas, such as an area between adjacent teeth portions. As a result, areas, such as the area between adjacent teeth portions, may contain the dental plaque which may lead to development of dental cavities and tartar.

Dental flossing is another method used to remove the food particles and the dental plaque from the teeth portions. The dental flossing is typically performed by using a floss that includes a nylon or a plastic filament. Generally, the floss is held in the hands and is gently inserted between the teeth portions and manually moved back and forth close to the gums for removing the food particles and the dental plaque from the teeth portions. However, such manual flossing is not effective in removing the dental plaque. Further, the manual flossing is also time consuming and difficult to perform by an individual.

Accordingly, there exists a need for an effective way of cleaning of the teeth portions for removal of the dental plaque. Further, there exists a need to preclude manual flossing of the teeth portions for removal of the dental plaque.

### SUMMARY OF THE DISCLOSURE

In view of the foregoing disadvantages inherent in the prior art, the general purpose of the present disclosure is to provide a dental floss apparatus to include all the advantages of the prior art, and to overcome the drawbacks inherent therein.

Accordingly, an object of the present disclosure is to provide an effective way of cleaning of teeth portions for removal of dental plaque.

Another object of the present disclosure is to preclude a need to manually floss the teeth portions for removal of the dental plaque.

In light of the above objects, in one aspect of the present disclosure, a dental floss apparatus is provided. The dental floss apparatus comprises a body member and a shaft member. The body member comprises a broad proximal end portion and a narrow distal end portion. The broad proximal end portion comprises an attachment mechanism for attaching to an elongated handle member. The narrow distal end portion terminates in a protruding member. The shaft member comprises a first end portion and a second end portion. The first end portion comprises a hollow portion for being removably received over the protruding member thereon. The second end portion comprises a forked tip portion disposed at a pre-determined angle to an axial line connecting the first end portion and the second end portion. The forked tip portion comprises a flossing member disposed therebetween. The flossing member is capable of being energized by a power source and is further capable of motion in at least one direction on being energized by the power source.

The configuration of the forked tip member at the predetermined angle enables an up and down direction of motion of the flossing member thereby providing an effective way of cleaning of the teeth portions for removal of the dental plaque. Moreover, the power source imparting the motion to the flossing member precludes the need of manually flossing the teeth portions for removal of the dental plaque.

This together with other aspects of the present disclosure, along with the various features of novelty that characterize the present disclosure, is pointed out with particularity in the claims annexed hereto and form a part of this present disclosure. For a better understanding of the present disclosure, its operating advantages, and the specific objects attained by its uses, reference should be made to the accompanying drawing and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates an exploded view of a dental floss apparatus for depicting various components of the dental floss apparatus, in accordance with an embodiment of the present disclosure; and

FIG. 2 illustrates an assembled view of the dental floss apparatus of FIG. 1, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in composition, structure, and design. It should be emphasized, however, that the present disclosure is not limited to a dental floss apparatus as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present disclosure provides a dental floss apparatus for providing an effective way of cleaning of teeth portions for removal of dental plaque. The dental floss apparatus further provides an effective way of cleaning gums thereby precluding risk of contracting gingivitis. Furthermore, the dental floss apparatus precludes the need of manually flossing the teeth portions for removal of the dental plaque thereby reducing time and effort required for flossing the teeth portions.

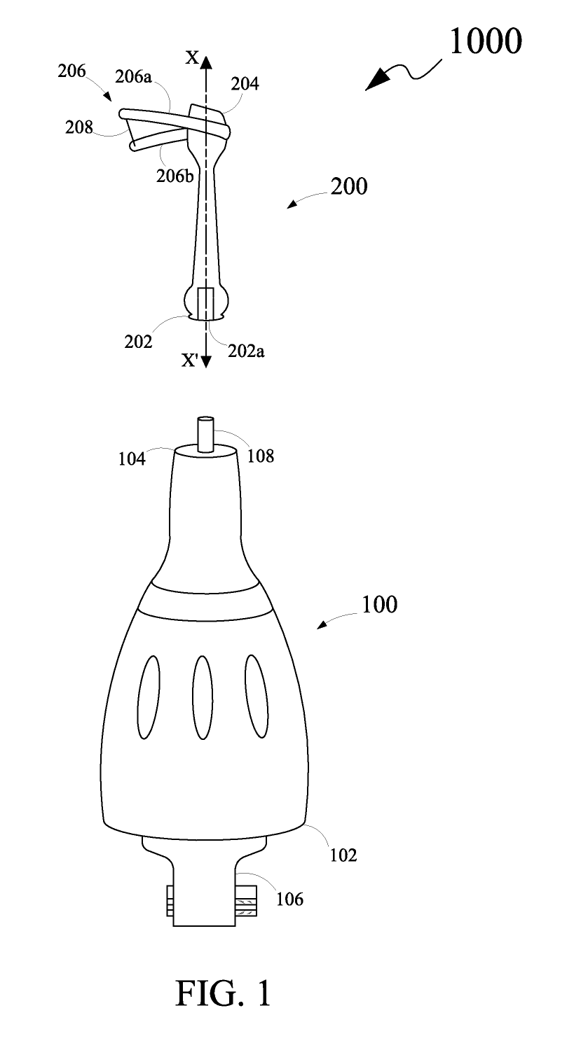

Referring now to FIG. 1, an exploded view of a dental floss apparatus 1000 is illustrated for depicting various components of the dental floss apparatus 1000, in accordance with an embodiment of the present disclosure. The dental floss apparatus 1000 includes a body member 100 and a shaft member 200. The body member 100 includes a broad proximal end portion 102 and a narrow distal end portion 104. The broad proximal end portion 102 includes an attachment mechanism 106 for attaching to an elongated handle member (not shown). More specifically, the attachment mechanism 106 of the broad proximal end portion 102 enables an attachment of the body member 100 to the elongated handle member. The elongated handle member may be a typical electrical toothbrush handle member capable of receiving a bristle replacement-head thereon. Such an elongated handle member typically includes housing for accommodating a power source such as a battery unit. The battery unit may be one of a disposable battery unit and a rechargeable battery unit. The rechargeable battery unit may be charged using typical charging dockets or may be charged directly from any electric power supply source. The narrow distal end portion 104 of the body member 100 terminates in a protruding member 108.

The shaft member 200 comprises a first end portion 202 and a second end portion 204. The first end portion 202 comprises a hollow portion 202a for being removably received over the protruding member 108 thereon. More specifically, the protruding member 108 may be received into the hollow portion 202a for coupling the shaft member 200 to the body member 100. In an embodiment of the present disclosure, the hollow portion 202a may be structurally configured to receive the protruding member 108 in a snap-fit manner. Alternatively, a suitable sealant may be utilized for engaging the protruding member 108 into the hollow portion 202a for coupling the shaft member 200 to the body member 100. The second end portion 204 is configured opposite to the first end portion 202.

The second end portion 204 comprises a forked tip portion 206 disposed at a pre-determined angle to an axial line X-X′ connecting the first end portion 202 and the second end portion 204. The forked tip portion 206 comprises a flossing member 208 disposed therebetween. More specifically, the forked tip portion 206 comprises a pair of arm extensions, such as an arm extension 206a and an arm extension 206b, laterally spaced apart, and, the flossing member 208 is disposed in-between the laterally spaced apart arm extensions of the forked tip portion 206.

The flossing member 208 is capable of being energized by the power source disposed in the elongated handle member. The flossing member 208 on being energized by the power source is capable of motion in at least one direction. More specifically, the power source disposed in the elongated handle member may energize the shaft member 200, which may trigger a movement of the forked tip portion 206 in at least one direction, such as a up and down direction or a side-to-side (sideways) movement of the forked tip portion 206 with respect to the axial line X-X′ connecting the first end portion 202 and the second end portion 204. The movement of the forked tip portion 206 may enable the motion of the flossing member 208 in the direction of movement of the forked tip portion 206. It will be evident to those skilled in the art that the body member 100 coupled to the shaft member 200 may be attached to the elongated handle member for energizing the flossing member 208. Further, it will be obvious to a person skilled in the art that the elongated handle member may further include a motor (not shown) and requisite electrical circuitry (not shown) for enabling an electrical coupling of the flossing member 208 to the power source. Furthermore, the elongated handle member may include a switch member for triggering the motor and thereby the movement of the forked tip portion 206 for enabling the motion of the flossing member 208 in the at least one direction.

In an embodiment of the present disclosure, the pre-determined angle of the forked tip portion 206 is about 90 degrees to the axial line X-X′ connecting the first end portion 202 and the second end portion 204. The pre-determined angle of 90 degrees of the forked tip portion 206 enables an up-and down direction of the motion of the flossing member 208, when energized, thereby providing an effective cleaning of the teeth portions for removal of the dental plaque. In another embodiment of the present disclosure, a direction of the at least one direction of the motion of the flossing member 208 is a side-to-side direction. The side-to-side direction of the motion and the up and down direction of the motion of the flossing member 208 may be utilized by the individual to reach inaccessible areas between the teeth portions for an effective cleaning of the teeth portions for removal of the dental plaque.

The power source is capable of imparting a vibrational motion to the flossing member 208 in the at least one direction. In one embodiment of the present disclosure, a frequency of the vibrational motion imparted to the flossing member 208 may be a sonic wave frequency. The flossing member 208 vibrating with sonic wave frequency may be introduced between adjacent teeth portions for effective cleaning of the teeth portions for removal of the dental plaque. In another embodiment of the present disclosure, the frequency of the vibrational motion imparted to the flossing member 208 is about 31,000 strokes per minute.

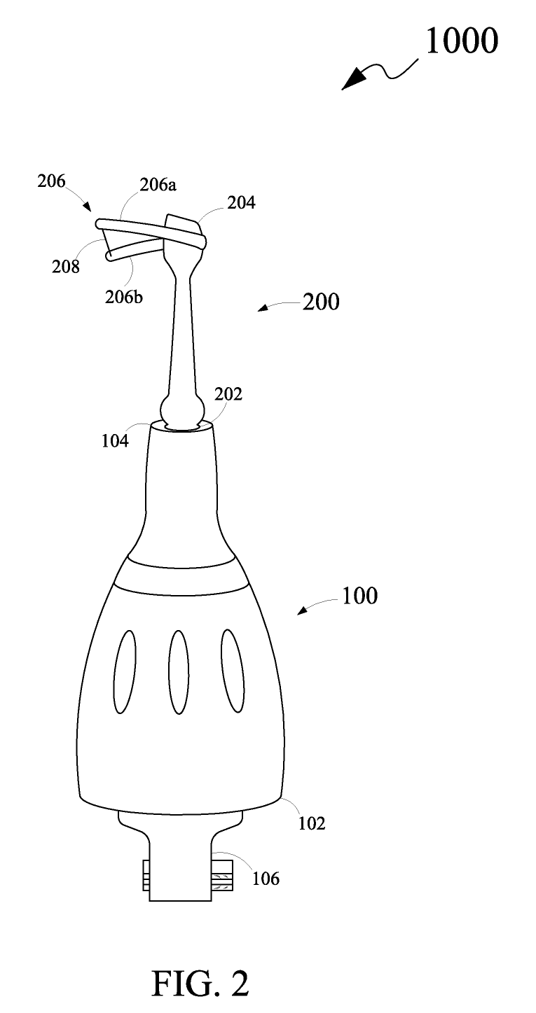

In an embodiment of the present disclosure, the body member 100 and the shaft member 200 are composed of durable plastic material. However, it will be evident to those skilled in the art that any such durable material may be utilized for configuring the body member 100 and the shaft member 200. An assembled view of the body member 100 and the shaft member 200 is depicted in FIG. 2.

Now referring to FIG. 2, an assembled view of the dental floss apparatus 1000 of FIG. 1 is illustrated, in accordance with an embodiment of the present disclosure. As explained in conjunction with FIG. 1, the body member 100 may be coupled to the shaft member 200 by receiving the protruding member 108 of the body member 100 into the hollow portion 202a of the shaft member 200. The assembled dental floss apparatus 1000 may then be coupled to the elongated handle member as explained in FIG. 1. The power source in the elongated handle member may be utilized for energizing the flossing member 208 for performing the motion in the at least one direction for effective cleaning of the teeth portions for the removal of the dental plaque.

In an embodiment of the present disclosure, a brush head portion of a typical toothbrush replacement head (about 1½ inches in length) is removed for configuring the body member 100, and, a tip portion about 1¼ inches long is shaved from a typical manual dental flosser for configuring the shaft member 200. Typically, a steel post is provided in the toothbrush replacement head for bearing the brush head portion. On removing the brush head portion from the toothbrush replacement head, the steel post may be exposed and may serve as the protruding member 108 in such a configured body member 100. Further, a bore, about ¾ inches deep, may be drilled in the configured shaft member 200 for forming a hollow portion, such as the hollow portion 202a. The steel post of the body member 100 exposed by removing the brush head portion of the typical toothbrush replacement head may then be inserted in the hollow portion 202a of the shaft member 200 at a 90 degrees angle and snap-fitted using a sealant for configuring the dental floss apparatus 1000. A height dimension and a width dimension of the dental floss apparatus 1000 configured in such a manner may be about 4½ inches and 1⅜ inches, respectively. It will be evident to those skilled in the art that such a configuration of the dental floss apparatus 1000 is illustrated for exemplary purposes only and that various such arrangements may be contemplated for configuring the dental floss apparatus 1000.

Various embodiments of the present disclosure offer following advantages. A dental floss apparatus, such as the dental floss apparatus 1000, is capable of effectively cleaning the teeth portions for removal of dental plaque and prevention of tartar formation. Further, the dental floss apparatus is capable of removing plaque and tartar below gum line, thereby, precluding the risk of diseases, such as gingivitis. Furthermore, a forked tip portion, such as the forked tip portion 206 configured at an predetermined angle, such as 90 degrees angle, enables an up and down direction of the motion of a flossing member, such as the flossing member 208, thereby providing an effective cleaning of the teeth portions. Furthermore, cleaning the teeth portions with the dental floss apparatus provides a clean and tingling sensation to a mouth portion of the individual. Also, the power source is capable of enabling a vibrational motion of the flossing member at a sonic wave frequency, which enables cleaning of the teeth portions and removal of tartar and plaque in an effective manner. Moreover, the power source imparting the motion to the flossing member precludes the need of manually flossing the teeth portions for removal of the dental plaque, thereby saving time and effort for the individual.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is

1. A dental floss apparatus, the dental floss apparatus comprising:
a body member comprising a broad proximal end portion and a narrow distal end portion, the broad proximal end portion comprising an attachment mechanism for attaching to an elongated handle member, the narrow distal end portion terminating in a protruding member; and
a shaft member comprising a first end portion and a second end portion opposite to the first end portion, the first end portion comprising a hollow portion for being removably received over the protruding member thereon, the second end portion comprising a forked tip portion disposed at a pre-determined angle to an axial line connecting the first end portion and the second end portion, the forked tip portion comprising a flossing member disposed therebetween, wherein the flossing member is capable of being energized by a power source disposed in the elongated handle member, and,
wherein the flossing member is capable of motion in at least one direction on being energized by the power source.

2. The dental floss apparatus of claim 1, wherein the pre-determined angle of the forked tip portion is about 90 degrees to the axial line connecting the first end portion and the second end portion.

3. The dental floss apparatus of claim 1, wherein a direction of the at least one direction of the motion of the flossing member is an up and down direction of the motion of the flossing member.

4. The dental floss apparatus of claim 1, wherein a direction of the at least one direction of the motion of the flossing member is a side-to-side direction of the motion of the flossing member.

5. The dental floss apparatus of claim 1, wherein the power source is capable of imparting a vibrational motion to the flossing member in the at least one direction.

6. The dental floss apparatus of claim 5, wherein a frequency of the vibrational motion imparted to the flossing member is a sonic wave frequency.

7. The dental floss apparatus of claim 5, wherein a frequency of the vibrational motion imparted to the flossing member is about 31,000 strokes per minute.
